(19) United States
(12) Patent Application Publication
(10) Pub. No.: US 2011/0262785 A1
(43) Pub. Date: Oct. 27, 2011

(54) BATTERY MODULE

(76) Inventors: KARL ASHLEY JOHNSON, SAN FRANCISCO, CA (US); PAUL YOUNG DURKEE, SAN FRANCISCO, CA (US)

(21) Appl. No.: 13/092,690

(22) Filed: Apr. 22, 2011

Related U.S. Application Data
(60) Provisional application No. 61/327,076, filed on Apr. 22, 2010.
(60) Provisional application No. 61/409,015, filed on Nov. 1, 2010.

(51) Int. Cl. H01M 10/42

(52) U.S. Cl. 429/66

(57) ABSTRACT

A battery module that includes a battery unit composed of a plurality of flat cells and having an end face, a container with an end piece that encloses the battery unit, and a damping assembly disposed between the end face and the end piece. The damping assembly includes a pressure plate, coupled to the end face, that distributes a force substantially equally over the end face. The damping assembly further includes a damping mechanism that damps battery unit oscillations within the container and applies the force to the pressure plate. Coupling the end plate to the damping mechanism compresses the damping mechanism, and causes the damping mechanism to exert a reactionary force against the pressure plate. Furthermore, the damping assembly compresses and substantially suspends the battery unit within the container, such that one face of the battery unit does not substantially contact the container interior.

### CROSS-REFERENCE TO RELATED APPLICATIONS

This application claims the benefit of U.S. Provisional Applications 61/327,076 filed 22 Apr. 2010 and 61/409,015 filed 1 Nov. 2010, which are both incorporated herein in their entirety by this reference.

### TECHNICAL FIELD

This invention relates generally to the battery pack field, and more specifically to a new and useful battery pack construction and arrangement in the multi-celled battery pack field.

### BACKGROUND

The current trend of mobile electronic devices is to provide increased functionality, mobility, and/or increased usage time while away from a stationary power source such as a wall outlet or recharge station. As a result, the power and/or energy requirements of portable power sources are increasing. In addition, the current trend of mobile electronic devices is to become lighter and more portable, leaving less volume for the portable power source. To accommodate this trend, power sources with higher power and energy densities are desirable. In electric vehicles such as motorcycles, power and energy density is especially important in allowing the vehicle to carry enough portable power to match the power and driving range provided by conventional fuel powered vehicles within the constraints of the vehicle frame. Higher power and energy densities may be achieved by packing a larger number of battery cells into a volume and/or using cells that contain chemistries with higher power and energy densities. As seen in the field of portable battery packs, cells with a prismatic shape (such as lithium polymer cells) are being considered to increase packing efficiency and achieve power sources with higher power and energy densities. Prismatic cells typically include an internal layer structure of anode, cathode, and polymer layers that are stacked to form the prismatic shape of the battery. Because of the internal layer structure of prismatic cells, prismatic cells may increase in thickness (as much as 10% increase in thickness) throughout the life cell. Because prismatic cells may be stacked within battery packs, this increase in thickness may cause for misalignment and damaged electrical connections within the cell and/or within the battery pack. Additionally, the internal layers may separate through the life of the cell, leading to less optimal contact between layers and potentially decreasing the efficiency and life of the cell.

Thus, there is a need in the multi-celled battery pack field to create a new and useful battery module for prismatic cell battery packs that accommodates to expansion of the cells and substantially prevents internal layer separation within each cell, potentially increasing the efficiency and life of the battery pack. This invention provides such new and useful battery module.

### BRIEF DESCRIPTION OF THE FIGURES

FIGS. 1A, and 1B are schematic representations of a cutaway view and an assembled view of an embodiment of the battery pack.

FIGS. 2A, 2B, and 2C are schematic representations of a main electrical conductor coupled to an external connection, cell electrical conductors coupled to a main electrical conductor, and the main electrical conductor, respectively.

FIG. 3 is a schematic representation of a second embodiment of the main electrical conductor.

FIG. 4 is a schematic representation of a first embodiment of the battery pack.

FIGS. 5A, 5B, and 5C are schematic representations of a first, second, and third variation of a damper, respectively.

FIG. 7 is a schematic representation of a second embodiment of the battery pack.

FIG. 8 is a schematic representation of a battery pack further including a divider plate.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

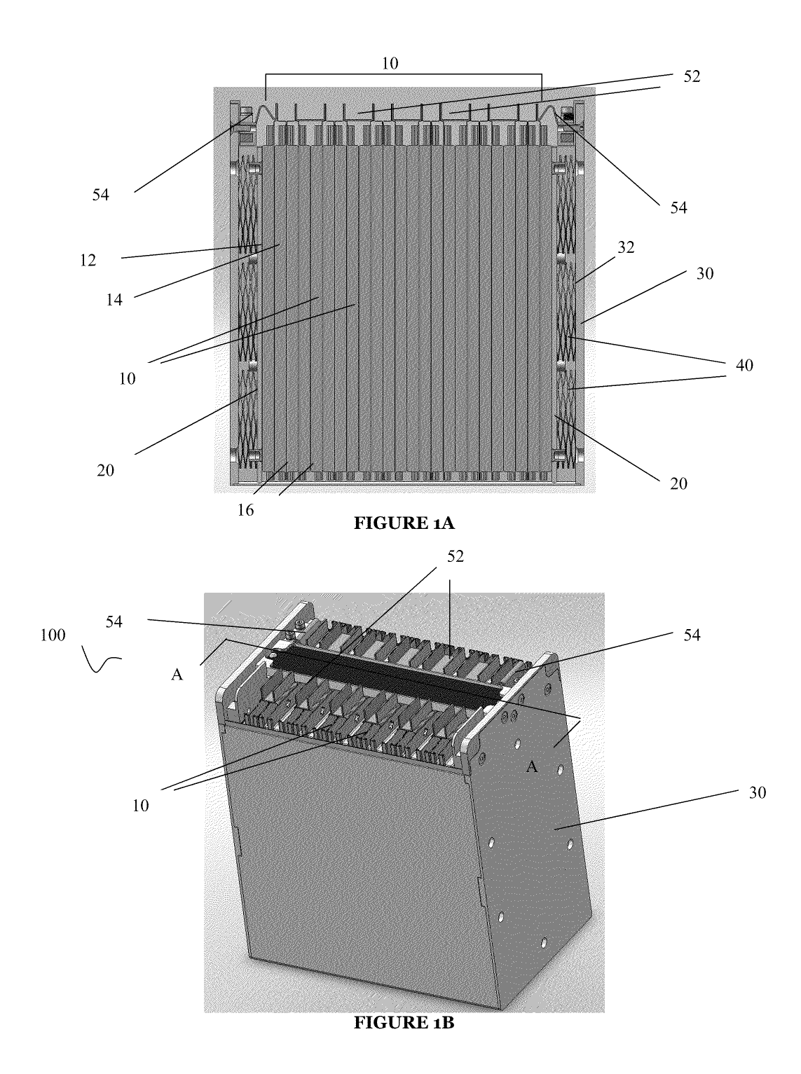

As shown in FIG. 1, the battery pack 100 of the preferred embodiments includes a plurality of prismatic cells 10 coupled to each other to form a block of cells 10 with two end faces, a pressure plate 20 coupled to one of the end faces of the block of cells 10, a container 60 with an end plate 30 that houses the plurality of cells 10 and the pressure plate 20 with an inside wall 32 that faces the pressure plate 20, and a damping element 40 that is coupled to the pressure plate 20 and the inside wall 32 of the end plate 30 to provide a pressure on the cells 10 as the cells 10 move and expand through use. Each of the prismatic cells 10 preferably includes a front main face 12 and a back main face 14 that is opposite of the front main face 12, and the two end faces of the block of cells 10 are preferably substantially parallel to each of the front and back main faces 12 and 14 of each cell 10. The battery pack 100 may also include cell electrical conductors 52 that electrically couple each cell 10 to an adjacent cell 10 and a main electrical conductor 54 that mechanically couples the cells 10 to the container 60 and functions as a main electrical connection for the battery pack 100. The battery pack 100 is preferably used in a moving vehicle, for example, an electric motorcycle or an electric car, but may alternatively be used in a stationary system, for example, backup power supplies, energy storage at electric power generation plants, or any other suitable system that utilizes prismatic cells.

As shown in FIG. 1A, the battery pack 100 of the preferred embodiments functions to provide a substantially constant pressure to the cells 10 through the life of the battery pack 100, which decreases the rate of separation between the layers within the prismatic cells 10 and may increase the efficiency and life of the cells 10. Because the cells 10 expand during use, a fixed element, for example, an end plate 30 that provides a pressure on the cells 10, will not be able to provide a substantially constant pressure onto the cells 10 through the life of the battery pack 100. Instead, a fixed element will provide increasing pressure as the cells 10 expand. Additionally, if the pressure provided onto the cells 10 is too high, the cells 10 and/or the container 60 may be damaged. Furthermore, the battery pack 100 may be subject to sudden shocks or vibrations during operation, which may cause the cells 10 to vibrate or oscillate within the container 60, potentially damaging the cells 10 and/or the container 60. In the battery pack 100 of the preferred embodiment, the damping element 40 functions to provide a substantially constant pressure on the cells 10 to accommodate cell 10 expansion as well as to damp cell 10 oscillations within the container 60. The damping element 40 is preferably preloaded upon assembly into the battery pack 100 between the pressure plate 20 and the inside wall 32 of the end plate 30 such that a pressure is provided onto the block of cells 10 through the pressure plate 20 throughout the life of the battery pack 100. The pressure plate 20 functions to distribute the force provided by the damping element 40 into a substantially even pressure that is applied across the surface area of the faces 12 and 14 of each of the cells 10. By utilizing a damping element 40, the pressure plate 20 is allowed to move relative to the end plate 30 with the cells 10 as the cells 10 expand and move during use, compressing and/or extending the damping element 40. The damping element 40 preferably provides a substantially constant pressure throughout the total displacement of the pressure plate 20 during the life of the battery pack 100. The battery pack 100 preferably includes two damping elements 40, wherein the damping elements 40 preferably provide enough force to suspend the cells 10 within the container 60. However, the battery pack may include any suitable number of damping elements 40 (e.g. one, three, etc.) that provide a compressive force to the cells 10 with or without suspending the cells 10 within the container 60.

The cells 10 of the preferred embodiment function to store and provide electrical energy. As shown in FIG. 1A, the cells 10 are preferably packed close to each other within the battery pack 100, forming a battery unit, to decrease the overall size of the battery pack, or, in other words, to increase the energy density of the battery pack 100. The cells are preferably placed adjacent to each other (or “stacked”) with the front main face 12 of one cell 10 coupled to either the front main face 12 or back main face 14 of an adjacent cell 10. The cells 10 are preferably coupled to each other with an adhesive 16 that couples a front main face with either the front main face 12 or the back main face 14 of an adjacent cell. The adhesive 16 is preferably a thin adhesive (on the order of 5-10 thousandths of an inch or less, but may alternatively be any other suitable thickness) to decrease the space between cells 10, thus decreasing the overall size of the battery pack. The adhesive 16 is preferably also substantially resistive to deformation from shear forces caused by gravity or vibration of the battery pack 100. On commonly available prismatic cells 10, the front or back main faces 12 and 14 may be uneven and include bumps or irregularities. These bumps or irregularities may be a result of the manufacturing process of the cell 10 or manufacturing differences between cells 10 or within the layers of the cell 10. Because of such irregularities, the adhesive 16 preferably also forms to the face 12 or 14 to substantially bond to the full surface area of the face 12 or 14. As mentioned above, pressure provided by the damping element 40 is preferably evenly distributed on the surface area of the faces 12 and 14 of each of the cells. Thus, the adhesive 16 preferably forms to the face 12 or 14 to evenly distribute the pressure provided by the damping element 40 across the surface area of the face. The adhesive 16 preferably forms to the face of the cell 10 after application (for example, the adhesive 16 forms to the face with time). Alternatively, the adhesive 16 may be formed to the face of the cell through the application process. For example, the adhesive may be heated to increase pliability of the adhesive, facilitating the process of forming to the face cell 10. However, the adhesive 16 may form to the face of the cell 10 using any other suitable method. The adhesive 16 may be double sided tape, such as the VHB brand produced by 3M. Alternatively, the adhesive 16 may include a layer of foam or other force distributing material to facilitate the distribution of pressure across the face of the cell 10. However, any other suitable arrangement of the adhesive 16 may be used.

As shown in FIG. 1A, the pressure plate 20 of the preferred embodiment functions to define a structure, adjacent to the cells, for the application of pressure from the damping element 40 over the face of the adjacent cell. As aforementioned, the pressure plate preferably distributes the pressure substantially equally over the face of the adjacent cell, preferably in a direction normal to the cell face. The pressure plate 20 is preferably coupled to an end face of the block of cells 10 and preferably travels with the block of cells 10. Similar to the cells 10, the pressure plate 20 is preferably coupled to the end face of the block of cells 10 using a pressure plate adhesive that is substantially similar or identical to the adhesive 16. However, the pressure plate adhesive may be of any other suitable type. Alternatively, the pressure plate 20 may be friction coupled to the cells 10, in other words, the force resulting from the pressure provided by the damping element 40 may push the pressure plate 20 into the cells 10 with enough force to maintain substantially constant contact between the pressure plate 20 and the cells 10. However, any other suitable arrangement to couple the pressure plate 20 to an end face of the block of cells 10 may be used. The pressure plate 20 may also include a buffer material arranged between the pressure plate 20 and the end face of the block of cells 10 that prevents direct contact between the pressure plate 20 and the cells 10. The buffer material may function to prevent abrasion between the pressure plate 20 and the cells 10, which may damage the cells 10 through the life of the battery pack. The buffer material may also function to facilitate substantially evenly distributing the pressure provided by the damping element 40 across the surface area of the faces 12 and 14 of each cell. The buffer material may be of a foam material, a cork material, or any other suitable material. However, any other suitable type of buffer material may be used. The pressure plate 20 is preferably flat and of a substantially rigid material that does not deform from the force provided by the damping element 40. If the pressure plate 20 deforms from the force from the damping element 40, then the pressure provided by the damping element 40 may be unevenly distributed to the cells 10. The pressure plate 20 is also preferably substantially thin to decrease the overall size of the battery pack 100. The pressure plate 20 is preferably composed of an injection molded plastic part, but may alternatively be aluminum, steel or any other suitable material that is manufactured using any other suitable process. The pressure plate 20 may include seats or grooves that function to locate the damping element 40 relative to the pressure plate 20 and/or the inside wall 32 of the end plate 30. However, any other suitable arrangement of the pressure plate 20 may be used.

The container 60 of the preferred embodiment functions to provide support for the damping element 40, as well as to load the damping element 40 with end plate 30 such that the damping element 40 provides pressure to the cells 10. The container 60, which is preferably a rigid container that includes a substantially rigid inside wall 32, preferably houses the cells 10 and the pressure plate 20 (and subsequently, the damping element 40). The container 60 is preferably of a substantially rectangular prism shape to accommodate to the prismatic the cells 10 and the rectangular prism shape of the block of cells 10. The volume defined by the container 60 is preferably substantially similar to the volume of the block of cells 10 with additional volume used for the pressure plate 20 and the damping element 40, electrical conductors 52, main electrical conductors 54, and/or cell management circuitry for the battery pack 100. The unoccupied volume within the container 60 is preferably small to maintain the small overall size of the battery pack 100 and to increase the power density of the battery pack 100. The container 60 may be completely enclosed during use to prevent undesired contact between the user and the cells 10, but may alternatively be arranged in any other suitable manner. The container 60 is preferably composed of metal, such as aluminum or steel, but may alternatively be made of plastic. The container 60 may be an assembly of walls (including end plate 30), but may alternatively be a unitary piece that is cast or molded. However, any other suitable type of material or manufacturing process may be used for the container 60.

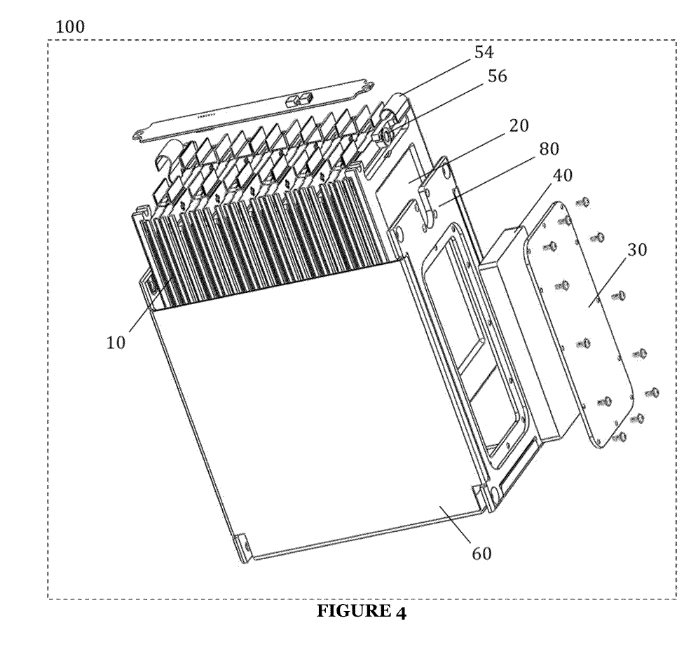

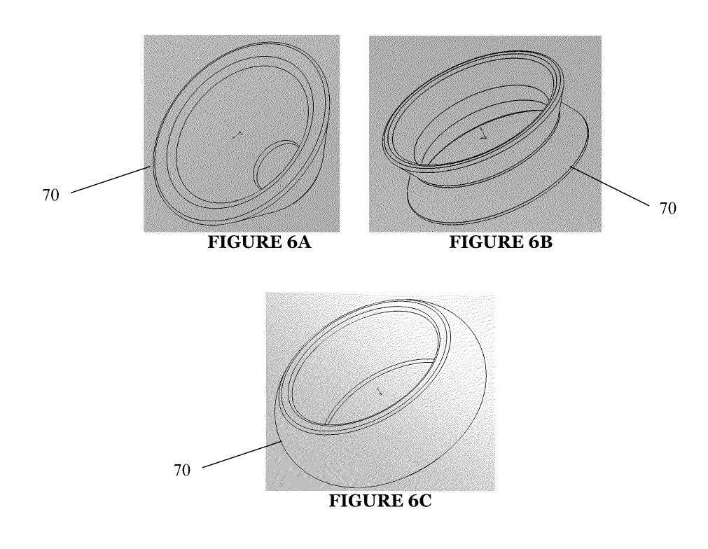

As shown in FIGS. 4 and 7, the container 60 may additionally include a mount 80. The mount 80 functions to couple the end plate 30 to the container 60 body, and preferably defines damping element locating geometry, through which the damping element 40 extends to couple with the pressure plate 20. The mount 80 is preferably located on the container 10 end adjacent the end plate 30, such that the mount 80 is substantially contained within the container 10 when the container 10 is sealed with the end plate 30. The mount 80 preferably couples to the perimeter of the end plate 30, but may alternately couple to other portions of the end plate 30 (e.g. the center of the end plate, or the exterior surface of the end plate). The mount preferably couples to the end plate via screws through the end plate and mount, but may alternately be adhered to the end plate, welded to the end plate, receive the end plate in an internal groove, or utilize any other means of coupling to the end plate. The damping element locating geometry defined by the mount 80 functions to locate and retain the position of the damping element 40 relative to the container, wherein the locating geometry preferably comprises a hole through the thickness of the mount 80 with geometry substantially similar to the damping element 40 (as shown in FIG. 7). However, the mount may alternately comprise one side of the locating geometry, wherein the locating geometry is defined by the mount 80 and three sides of the container 60 (as shown in FIG. 4), two sides, or any number of sides to provide a mounting surface. The locating geometry may alternately be a pattern of circles, a grid, or any other geometry that locates the damping element 40 and allows the damping element to extend through to couple with the pressure plate 20. The mount 80 is preferably a unitary piece with the container 60, but may alternately be an insert that slides into grooves along the perimeter of the container 60. The mount 80 is preferably static relative to the container 60, but may alternately move with the pressure plate 20 as the cells 10 expand.

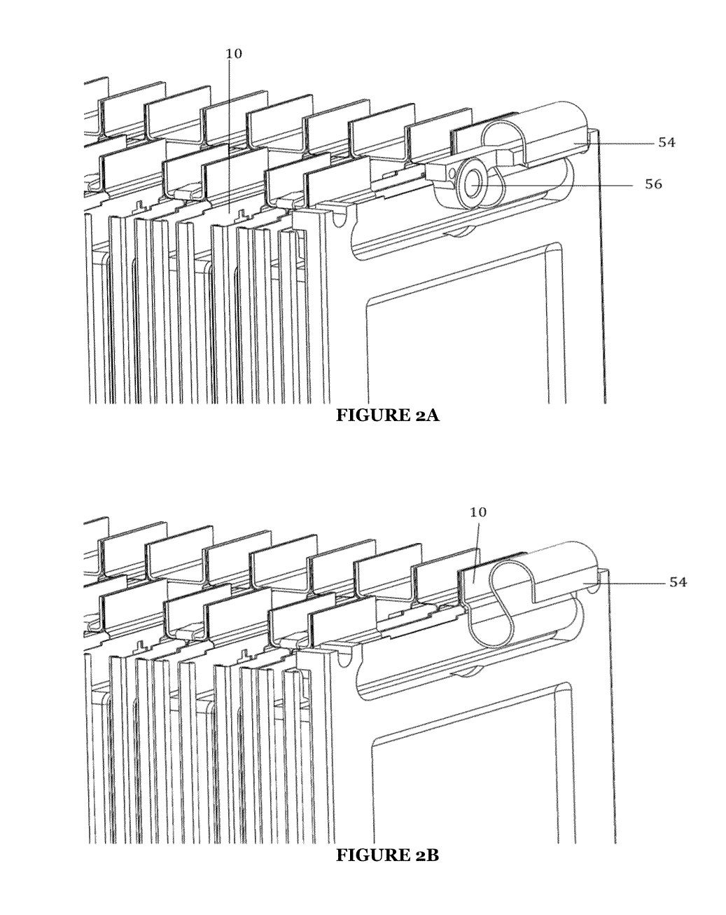

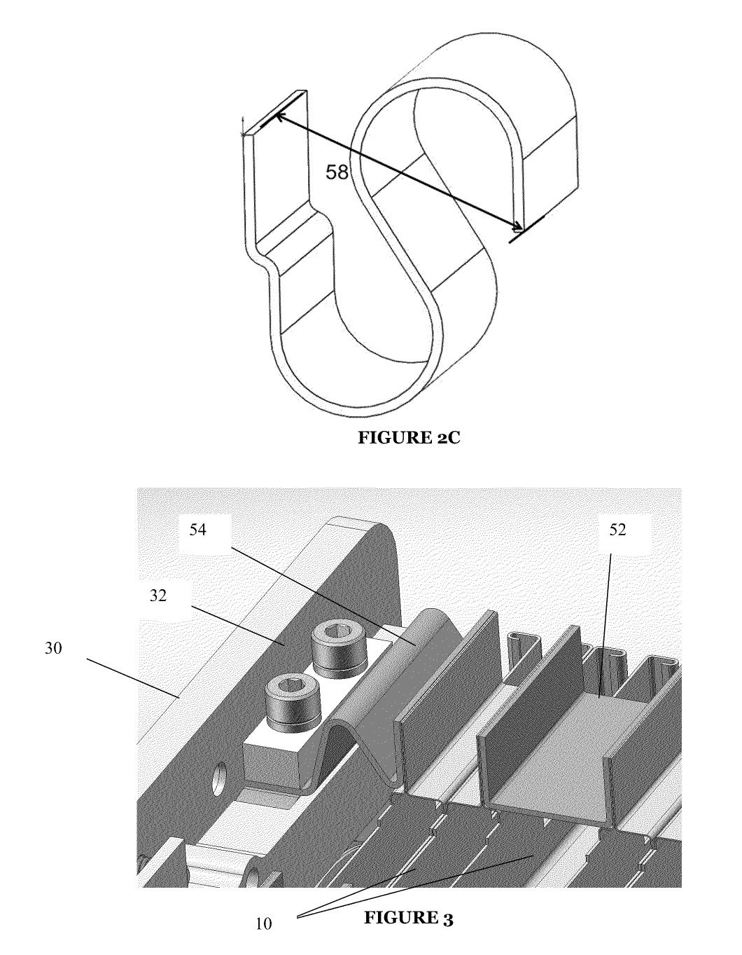

The container 60 preferably includes main electrical connectors 54 coupled to external connections 56 for access to the voltage potential within the battery pack 100 from outside the battery pack 100. As shown in FIGS. 1, 2, and 3, the external connection 56 preferably remains stationary relative to the container 60 as the cells 10 within the container 60 move and expand during use. By coupling the stationary external connection 56 to a flexible main electrical connector 54 (shown in FIG. 2A), an electrical connection can be maintained despite the movement and expansion of the cells 10, effectively decoupling the influence of the cells' 10 position from external electrical access. The main electrical conductor 54 is preferably includes one end that remains stationary relative to the container 60 and a second end that is electrically coupled to and moves with the cells 10, allowing the main electrical connections 56 of the container 60 to remain stationary relative to the container 60. In other words, the main electrical connector 54 preferably changes total length (as measured from main electrical connection 56 to the cells 10) as the battery unit moves within to the container. The main electrical conductor 54 is preferably composed of a pliable, electrically conductive material that maintains electrical connection with the cells 10 and the main electrical connection of the container 60 as the cells 10 move and expand. As shown in FIG. 2C, the main electrical conductor 54 includes an S-like shape that changes total length 58 with the movement and expansion of the cells 10. However, the main electrical conductor 54 may alternately have a wave-like shape (shown in FIG. 3), a J-like shape, or any other configuration that changes total length 58 with the movement and expansion of the cells 10. The main electrical conductor 54 is preferably made of a copper material, but may be made of any suitable conductive material. The main electrical conductor 54 is preferably a unitary sheet that is stamped into a S-shape, but may alternatively include a plurality of substantially thin sheets of copper that are layered, but not bonded, on top of each other, which may increase the pliability and reliability of the main electrical conductor 54. In this variation, the thin sheets of copper are preferably bonded to each other at the ends of the S shape to provide a substantially reliable electrical connection between the main electrical conductor 54 and an adjacent conductor. However, the main electrical conductor 54 may be of any other suitable arrangement to allow pliability while maintaining a suitable electrical connection. While the container 10 preferably includes two main electrical connectors 54, the container 10 may alternately include one or any suitable number of main electrical connectors 54.

As shown in FIG. 1, the damping element 40 of the preferred embodiment functions to provide the constant pressure of the system, and additionally functions to damp cell 10 oscillations within the container 60. The damping element 40 is preferably disposed between the pressure plate 20 and the end plate 30, wherein an end of the damping element 40 preferably nests in the seats of the pressure plate 20. The element 40 preferably exhibits viscoelastic properties (e.g. time dependent strain), but may alternately exhibit elastic properties only. Constant pressure is preferably applied to the system by leveraging the elasticity of the damping element 40; the end plate 30 of the container 60 preferably loads the damping element 40 such that damping element 40 is compressed and exerts a reactionary force against the cells 10. By providing force along the continuous surface of the pressure plate 20, the pressure to the faces damping 12 and 14 of each cell 10 may be better evenly distributed. Damping is preferably applied to the system by leveraging the viscosity of the damping element 40; because the elasticity of the damping element 40 causes the pressure plate 20 to substantially contact the cells 10 during operation, any shocks, vibrations or oscillations experienced by the cells 10 will be transmitted through the pressure plate 20 to the damping element 40, wherein the viscosity of the damping element may substantially prevent cell 10 movement and may additionally absorb and/or dissipate shock energy.

As shown in FIG. 4, a first embodiment of the damping element 40 preferably includes a plurality of individual springs. These springs are preferably evenly distributed along the surface of the pressure plate 20, and are preferably compressed along their longitudinal axis. By providing force along multiple points of the surface of the pressure plate 20, the pressure to the faces 12 and 14 of each cell 10 may be better evenly distributed. Each of the springs of the spring element 40 is preferably substantially identical to each other and is preferably selected based on several criteria. For a first criterion, each spring is preferably of a type that does not significantly increase spring force through the displacement of the cells 10 during use. More specifically, the spring constant and unloaded spring length of each of the springs is preferably chosen such that the expected displacement of the cells 10 during use is substantially small relative to the total unloaded spring length, resulting in a relatively small change in spring force over the expected displacement of the cells 10 during use. For a second criterion, the total length of the spring when compressed is preferably substantially small, thus allowing the size of the battery pack 100 to remain substantially small. For a third criterion, the spring constant is preferably substantially high to provide a suitable pressure to the cells 10. The spring element 40 preferably provides approximately 6 psi on the faces 12 and 14 of each cell 10. For a fourth criterion, the spring constant is preferably substantially constant for the spring throughout the compression range of the spring, allowing the spring force to be predictable. Some of these criteria result in contradictory spring selection. In particular, for the second and third criteria, a substantially small compressed length may mean substantially thin material for the spring. However, a substantially high spring constant may mean substantially thick material for the spring. In such cases, a compromise in performance is preferably used in spring selection. In a preferred embodiment, the spring element 40 includes six wave springs that are arranged symmetrically along the surface of the pressure plate 20. Each wave spring has a spring constant of approximately 7.1 N/mm and was sourced from Smalley Steel Ring Co. However, each spring may be of any other suitable spring constant, type, or source. Alternatively, the spring element 40 may be of a single large spring that is of substantially the same cross sectional area as the surface area of the pressure plate 20. However, any other suitable type of spring element 40 may be used.

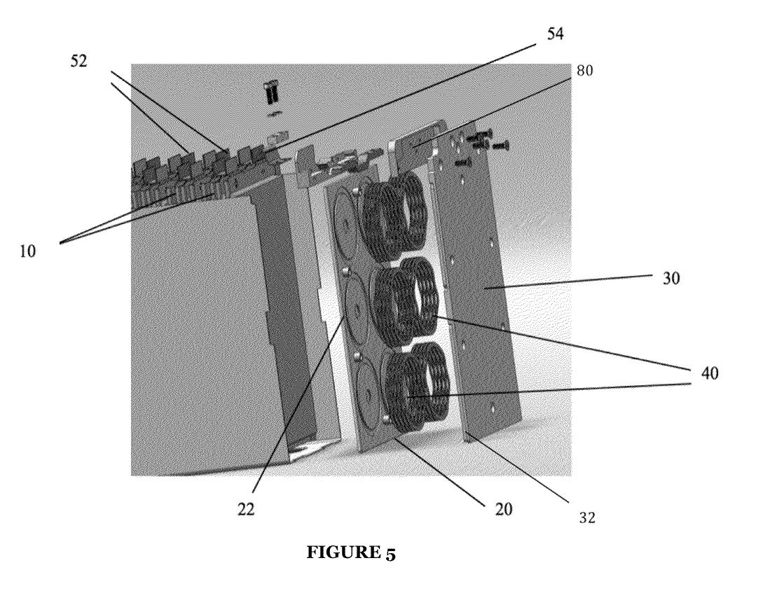

In this embodiment, the battery pack 100 may additionally include a damper 70 that functions to damp vibrations of the cells 10. The damper 70 is preferably placed between the pressure plate 20 and the interior wall 32. The damper 70 preferably accommodates to the movement and expansion of the cells 10 and preferably provides a substantially constant amount of damping force through the range of movement and expansion of the cells 10. The damper 70 is preferably made of a continuous piece of shaped rubber that preferably changes shape as the cells 10 expand and move and maintains substantially constant contact with both the pressure plate 20 and the interior wall 32. In a first example, the damper 70 may be shaped as a Bellville washer that flattens and/or expands as the cells move and expand, as shown in FIG. 5A. In a second example, the damper 70 may be shaped as a compressible hourglass shape that flattens and/or expands as the move and expand, as shown in FIG. 5B. In a third example, the damper 70 may be a ring shape that flattens and/or expands as the cells move and expand, as shown in FIG. 5C. However, the damper 70 may be of any other suitable type of material, geometry, or type.

As shown in FIG. 7, a second embodiment of the damping element 40 preferably comprises a substantially continuous piece of viscoelastic material, wherein the material deforms to absorb and distribute loads (e.g. shock and constant pressure from the container), but returns to its original shape after loading. The elastic material also preferably isolates the system from vibrations, such that the natural frequency of the cells 10 is lowered. The elastic material preferably damps vibrations, such that the energy from loads to the system (e.g. shock) are quickly dissipated and/or absorbed. Additionally, the material preferably has a long fatigue life, preferable because the battery pack 100 may be used for extended periods of time in high load applications with no periodic maintenance. The damping element 40 material also preferably has a low creep rate. Creeping of the damping element 40 causes, amongst other changes in material properties, the damping element 40 to become stiffer and to change dimensions, becoming thinner on the loading faces and expanding in the other dimensions. These changes lead to several issues. Firstly, the thinner damping element 40 may apply less force on the pressure plate 20, as the thinner damping element 40 is not compressed to the same degree as it was when it was thicker. Secondly, the stiffer damping element 40 may not isolate or damp vibrations as well as before the creep occurred, leading to possible cells 10 vibration and damage. Thirdly, deformation of the damping element 40 may inadvertently load other elements of the battery pack 100, such as expanding against the walls of the container 60 or against the cells 10. For these reasons, the damping element 40 is preferably comprised of a continuous piece of SORBOTHANE viscoelastic material (urethane foam rubber), but may alternately and/or additionally include neoprene, polyethylene, polyurethane, silicone, or any other suitable material in the form of foam, rubber, foam rubber or any other suitable form. The damping element 40 preferably has a geometry similar to the pressure plate 20, but may alternately be smaller than the pressure plate 20, larger than the pressure plate 20, similar to the geometry of the pressure plate groove, or any other suitable geometry. Furthermore, the damping element 40 preferably has an uncompressed thickness greater than the thickness of the window defined by the mount 80. However, the damping element 40 may alternately have an uncompressed thickness less than or substantially equal to the thickness of the damping element locating geometry, wherein features on the interior of the end piece 30 couple with and substantially compress the damping element 40.

Despite the low creep rate of the material, however, extended use of the battery pack may still result in substantial creep. To address this issue, the damping element 40 may include force adjusting mechanisms such as relief features, compression features and expansion features that allow the damping element 40 to be somewhat unloaded, further compressed, or allowed to expand, respectively. The damping element 40 may additionally include replacement features, which allow all or part of the damping element 40 to be replaced. Examples of relief features include a set of uncompressed springs coupled to the damping element 40 and the end plate 30, a ratcheting mechanism wherein mechanism activation moves the end plate 30 farther from the cells 10, or multiple layers of damping element 40 that can be removed as the battery pack 100 is operated, wherein the relief features may accommodate cell 10 expansion during use. Examples of compression features include a set of compressed springs coupled to the damping element 40 and the end plate 30 or a tightening mechanism coupled to the end plate 30 that, when activated, forces the inner wall of the container 32 closer to the cells 10 and retains the inner wall 32 in the new position, wherein the compression features may accommodate damping element 40 thinning. Examples of expansion features include patterning the damping element 40 (e.g. with two sets of interlocking “fingers,” periodic holes in damping element 40, or periodically occurring circular pieces of damping element 40 instead of a continuous piece) or a sliding mechanism that allows the container 60 to expand with the damping element 40, wherein the expansion features may provide space for the damping element 40 to expand without compressing other elements of the battery pack 100. Examples of replacement features include coupling the damping element 40 to the end plate 30 such that they can be replaced as a set or decoupling the damping element 40 from all other elements such that it can be replaced on its own, wherein the removal features may allow a damping element 40 that suffers from creep to be removed and replaced. Relief, compression, expansion, and replacement features may or may not be included in the battery pack 100 based on the type of material chosen for the damping element 40.

As shown in FIG. 1B, the battery pack 100 may also include a second pressure plate 20 that is coupled to the other end face of the block of cells 10, and a second damping element 40 that is coupled to the second pressure plate 20 and a second inside wall 32 of a second end plate 30 to provide a pressure on the cells 10 as the cells 10 move and expand through use. The second pressure plate 20 and the second damping element 40 are preferably identical to the pressure plate 20 and the damping element 40, respectively, but are preferably arranged as a mirror reflection from the pressure plate 20 and damping element 40 about a mid-plane of the battery pack. By arranging a pressure plate 20 and a damping element 40 on either side of the block of cells 10, the location of both ends of the cells 10 is substantially predictable during use. For example, during use of the battery pack 100 on a moving vehicle, the cells 10 may shift as the battery pack 100 moves. By arranging a pressure plate 20 and a damping element 40 on either side, it can be predicted that the forces from both pressure plates 20 and damping elements 40 substantially maintain the cohesiveness of the block of cells 10, and that both pressure plates 20 move with the block of cells 10 and that the end faces of the block of cells 10 are directly adjacent to the pressure plates 20. Furthermore, the first and second pressure plates 20, damping elements 40, and end plates 30 may cooperate to suspend the battery unit 10 within the container 60.

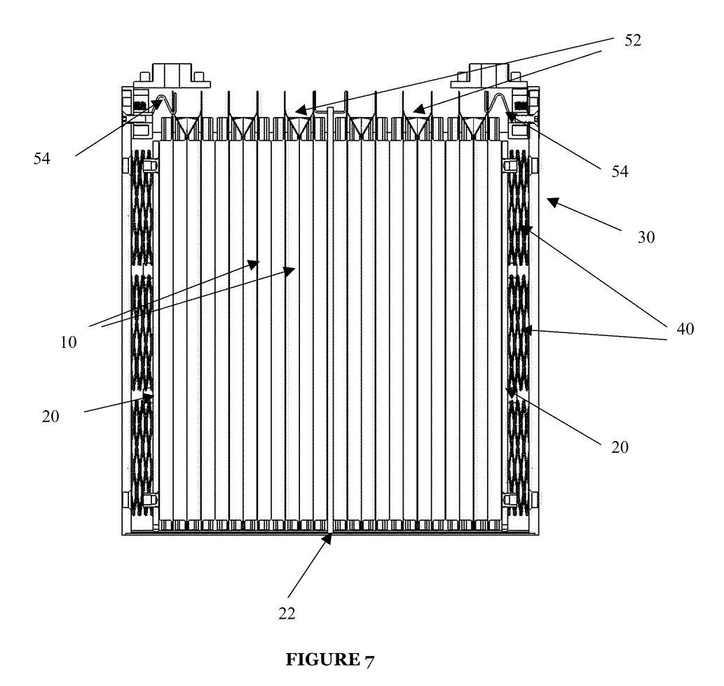

As shown in FIG. 8, the battery pack 100 may additionally include a divider plate 22, fixed to the container 60, that is arranged substantially in the middle of the block of cells 10 and functions to substantially decrease the amount of movement of the block of cells 10 from side to side. This may be similar to the variation of the battery pack 100 with only one pressure plate 20 and damping element 40 as mentioned above. However, in this variation, the block of cells 10 is substantially divided into two half-blocks of cells 10, which may function to decrease the detrimental effects of having only one pressure plate 20 and damping element 40 corresponding to each half-block of cells 10. For example, by placing the divider plate 22 in between the block of cells 10, the uncertainty of the location of the end face of each half-block may be decreased. The end face of each half-block of cells 10 may also be adhered to the divider plate 22. In this variation, because only half of the block of cells 10 is moving relative to the divider plate 22, the forces to pull the cells apart from each other may also be decreased. However, any other suitable arrangement may be used to decrease vibration forces within the battery pack 100. The battery pack 100 preferably includes one divider plate 22, but may include multiple divider plates 22, wherein the divider plates 22 preferably divide the battery unit 10 into substantially equal sub-Mocks.

As a person skilled in the art will recognize from the previous detailed description and from the figures and claims, modifications and changes can be made to the preferred embodiments of the invention without departing from the scope of this invention defined in the following claims.

We claim:

1. A battery module comprising:
a battery unit having an end face, the battery unit comprising a plurality of flat cells coupled together along the broad faces in the thickness direction, wherein the end face is an uncoupled broad face of the first cell in the battery unit;
a container enclosing the battery unit, the container including an end piece, adjacent the battery unit end face, the container further including a damping assembly disposed between the end face and the end piece, the damping assembly including:
a pressure plate coupled to the end face that distributes a force substantially equally over the end face;
a damping mechanism that damps oscillations of the battery unit within the container and applies the force to the pressure plate;
wherein the end piece couples to the damping mechanism such that the damping mechanism is disposed between the pressure plate and end piece, wherein coupling the end piece to the damping mechanism compresses the damping mechanism and generates the force;
wherein the damping assembly compresses and substantially suspends the battery unit within the container, such that the end face of the battery unit does not substantially contacts the container interior.

2. The battery module of claim 1, wherein each pressure plate further includes a groove that receives an end of the damping mechanism.

3. The battery module of claim 1, wherein the pressure plate is adhered to the end face.

4. The battery module of claim 1, further including a force distributing material between the end face and the pressure plate.

5. The battery module of claim 1, wherein the container further includes:
a second end piece adjacent a second end face, wherein the second end face is an uncoupled broad face of the last cell of the battery unit; and,
a second damping assembly located between the second end piece and the second end face, the second damping assembly comprising:
a second pressure plate coupled to the second end face that distributes a second force substantially equally over the second end face;
a second damping mechanism that damps oscillations of the battery unit within the container and applies the second force to the second pressure plate;
wherein the second end piece couples to the second damping mechanism such that the second damping mechanism is disposed between the second pressure plate and the second end piece, wherein the coupling of the second end piece to the container compresses the second damping mechanism and generates the force;
wherein the second force is applied in substantially the opposite direction of the first force, and wherein the first damping assembly and second damping assembly cooperate to suspend the battery unit.

6. The battery module of claim 5, further including a divider plate substantially disposed in the middle of the battery unit, such that the broad faces of the divider plate couple with the broad faces of adjacent cells, wherein the divider plate is fixed to the container interior.

7. The battery module of claim 1, wherein the damping mechanism includes a plurality of spring elements that are disposed to provide a substantially evenly distributed force over the pressure plate.

8. The battery module of claim 7, wherein the spring constants of the spring elements are substantially constant throughout the compression range of the spring elements.

9. The battery module of claim 8, wherein the springs are wave springs.

10. The battery module of claim 7, wherein the damping mechanism further includes a damping cone contained within each spring element, wherein the damping cone is substantially concentric with the spring element.

11. The battery module of claim 1, wherein the damping mechanism comprises viscoelastic damping material with a substantially low creep rate.

12. The battery module of claim 11, wherein the damping material is selected from the group consisting of urethane, polyurethane, polynorbornene, polyethylene, neoprene, and silicone.

13. The battery module of claim 11, wherein the damping material is substantially continuous and has substantially the same planar area as the end face.

14. The battery module of claim 13, wherein the damping mechanism includes expansion features that accommodate damping material expansion during compression.

15. The battery module of claim 14, wherein the expansion features include a plurality of holes through the damping material thickness, wherein the holes are substantially evenly distributed over the face of the damping material.

16. The battery module of claim 1, wherein the container further includes a mount, adjacent to the end face, that couples the end face to the container and defines damping mechanism locating geometry; the mount having a side proximal the battery unit and a side distal the battery unit, wherein the pressure plate is disposed on the proximal side of the mount and the end piece couples to the distal side of the mount; wherein the damping mechanism couples to the pressure plate through the locating geometry.

17. The battery module of claim 16, wherein the locating geometry comprises a hole running substantially through the center of the mount in the thickness direction, the hole having geometry substantially similar to the geometry of the damping mechanism, wherein the damping mechanism extends through the hole to couple to the pressure plate.

18. The battery module of claim 17, wherein the damping mechanism has an uncompressed thickness greater than the hole thickness, wherein coupling the end piece to the damping assembly compresses the damping mechanism.

19. The battery module of claim 16, wherein the damping assembly further includes a force adjusting mechanism that changes the force applied to the battery unit.

20. The battery module of claim 19, wherein the force adjusting mechanism increases the force magnitude.

21. The battery module of claim 20, wherein the force adjusting mechanism moves the damping assembly from a first position to a second position closer to the end face, and retains the damping assembly in the second position.

22. The battery module of claim 1 further including a pliable electrical connector with a battery unit end and a container end, wherein the battery unit end is electrically coupled to the battery unit and the container end is statically coupled to the container, wherein the battery unit end moves with the battery unit such that the connector changes total length as the battery unit moves.

23. The battery module of claim 22, wherein the electrical connector is S-shaped, wherein one end is the battery unit end and the other end is the container end.

24. The battery module of claim 22, wherein the electrical connector comprises copper.

25. A battery module comprising:
a battery unit comprising a plurality of prismatic cells, each cell including two opposing broad faces, wherein the plurality of prismatic cells are coupled together by the broad faces, the battery unit further comprising a rigid pressure plate coupled to an uncoupled broad face, wherein the pressure plate distributes a compressive force substantially equally over the uncoupled broad face;
a rigid container enclosing the battery unit and having a vacant end, wherein the vacant end is the container end adjacent the pressure plate;
a damping assembly that applies the force to the pressure plate, the damping assembly comprising:
a viscoelastic damping mechanism that damps battery unit oscillations within the container, wherein the damping mechanism couples to the pressure plate;
a rigid end plate coupled to the container and the damping mechanism, wherein the end plate substantially seals the vacant end and compresses the damping mechanism to generate the applied force.

26. The battery module of claim 25, wherein the pressure plate further includes grooves, wherein an end of the damping mechanism locates within the grooves.

27. The battery module of claim 25, further including a mount coupled to the vacant container end, the mount defining damping mechanism locating geometry, wherein the damping mechanism extends through the damping mechanism locating geometry to couple to the pressure plate, and wherein the damping mechanism has an uncompressed thickness greater than the mount thickness.

28. The battery module of claim 27, wherein the mount is a unitary piece with the container.

29. The battery module of claim 25, further including a second pressure plate coupled to the uncoupled broad face of a second cell and a second damping assembly substantially similar to the first damping assembly, wherein the first damping assembly and second damping assembly apply compressive normal forces to the battery unit and substantially suspend the battery unit within the container such that one face of the battery unit does not contact the container interior.

30. The battery module of claim 29, further including a rigid divider plate coupled to the container interior, the divider plate disposed substantially in the center of the battery unit, such that the broad faces of the divider plate couple to the broad faces of adjacent cells.

31. The battery module of claim 25, wherein the viscoelastic damping mechanism comprises a damping cone contained within a spring, the spring having a substantially constant spring constant throughout its compression range, wherein the damping cone is substantially concentric with the spring.

32. The battery module of claim 25, wherein the viscoelastic damping mechanism comprises a substantially continuous piece of viscoelastic material.

33. The battery module of claim 32, wherein the viscoelastic material includes a plurality of substantially evenly distributed holes thorough the damping material thickness.

34. The battery module of claim 33, wherein the viscoelastic material comprises urethane foam rubber.

35. The battery module of claim 25, further including a pliable electrical connector having a battery end electrically and statically coupled to the battery unit, and a container end statically coupled to the container, wherein the connector changes total length as the battery unit moves.
